(19) United States
(12) Patent Application Publication
(10) Pub. No.: US 2009/0104399 A1
(43) Pub. Date: Apr. 23, 2009

(54) Vibration welded joint structures, methods, and apparatus for thermoplastic members

(76) Inventor: Stephen Field, Ottawa (CA)

Correspondence Address: WENDEROTH, LIND & PONACK, L.L.P., 1030 15th Street, N.W.,, Suite 400 East, Washington, DC, 20005-1503, US

(21) Appl. No.: 12/227,290

(22) PCT Filed: May 15, 2007
(86) PCT No.: PCT/CA2007/000863

§ 371 Date: Nov. 13, 2008

Related U.S. Application Data
(63) Continuation-in-part of application No. 11/488,767, filed on Jul. 19, 2006.
(60) Provisional application No. 60/800,007, filed on May 15, 2006.

(51) Int. Cl. B32B 7/00; B29C 65/06

(52) U.S. Cl. 428/119; 156/73.5; 156/349

(57) ABSTRACT

Vibration welded joint structures, methods, and apparatus for thermoplastic members are disclosed. A welded joint structure includes first and second thermoplastic members and an interposed junction piece vibratory welded to the first and second members at respective welding surfaces. At least one of the welding surfaces partially defines an angle, in a plane normal to the interposed junction piece, between an unwelded portion of the first member and an unwelded portion of the second member. The junction piece may include surfaces for forming vibratory welded bonds with the first and second thermoplastic members and a component holder, physically coupled to those surfaces, for enabling the junction piece to hold a further component.

### CROSS-REFERENCE TO RELATED APPLICATIONS

This application is claims the benefit of U.S. Provisional Patent Application Ser. No. 60/800,007, filed on May 15, 2006.

This application also claims the benefit of U.S. patent application Ser. No. 11/488,767, filed on Jul. 19, 2006.

The entire contents of each of the above applications are hereby incorporated herein by reference.

### FIELD OF THE INVENTION

This invention relates generally to welding of thermoplastic members and more particularly to vibration welding of such members.

### BACKGROUND

There are some limitations with existing methods of vibration welding thermoplastic members. For example, existing methods relate primarily to joining mitre-cut members together. Also, where separate elements are used to join members together, these separate elements are used only to form a weld between thermoplastic members and do not serve any other purpose.

### SUMMARY OF THE INVENTION

Thus, there remains a need for improved vibration welding techniques and joint structures.

According to an aspect of the present invention, a welded joint structure includes first and second thermoplastic members and an interposed junction piece vibratory welded to said first member at a first welding surface and to said second member at a second welding surface, with at least one of said first welding surface and said second welding surface partially defining an angle, in a plane normal to said interposed junction piece, between an unwelded portion of said first member and an unwelded portion of said second member.

In some embodiments, each of said first member and said second member comprises an elongate member having an end surface and at least one side surface, and said at least one of said first welding surface and said second welding surface comprises a surface that is parallel to a respective side surface of said first member and said second member.

Each of said first member and said second member may comprise an elongate member having an end surface and at least one side surface, in which case said first welding surface may comprise a surface that is parallel to a side surface of said first member, and said second welding surface may comprise a surface that is parallel to said end surface of said second member. The first welding surface of said first member is proximate said end surface of said first member in some embodiments.

The first member may further comprise a second end surface, with at least one side surface of said first member connecting said end surface of said first member and said second end surface. The first welding surface of said first member may be disposed in a middle portion between said end surface of said first member and said second end surface of said first member.

The angle between the unwelded portion of said first member and the unwelded portion of said second member may be a right angle.

In some embodiments, said first member and said second member have different shapes, different sizes, or both different shapes and different sizes.

Each of said first member and said second member may be a thermoplastic extrusion or a thermoplastic pultrusion.

The first member and said second member comprise thermoplastic foam material in some embodiments.

The interposed junction piece itself may include a substantially flat strip of thermoplastic material, with an end surface of said second member incorporating a channel recess, and said side surface of said first member to which said first welding surface is parallel comprising a complementary channel recess.

Where the first member comprises a leg extension, the second member comprises a complementary recess for receiving said leg extension.

Such a welded joint structure may also include a compressible seal disposed in a junction between said leg extension and said recess.

The first welding surface, the second welding surface, and the interposed junction piece may comprise multiple faces. In this case, a face of said multiple faces of said at least one of said first welding surface and said second welding surface may partially define said angle between said unwelded portion of said first member and said unwelded portion of said second member in a plane normal to a face of said multiple faces of said interposed junction piece.

Each of said first and second members may comprise a hollow profile defined by at least one peripheral wall, with said at least one of said first welding surface and said second welding surface comprising a portion of a respective peripheral wall of said first member and said second member.

The hollow profile of said first member may incorporate a hollow leg member, with a part of said second member being removed exposing a cavity wall and creating a complementary recess for receiving said hollow leg member.

An end cap may be attached to an exposed hollow profile end of each of said first member and said second member that comprises said at least one of said first welding surface and said second welding surface.

The first member may incorporate a channel recess comprising said first welding surface, and second member may incorporate a complementary channel recess comprising said second welding surface, in which case the interposed junction piece incorporates a three-dimensional shape complementary to said channel recesses of said first member and said second member.

In some embodiments, each of said channel recesses has a wedge shape.

The interposed junction piece may comprise a series of surfaces vibratory welded to said first welding surface and a series of surfaces vibratory welded to said second welding surface, with the surfaces of each of said series of surfaces being separated by respective series of recesses.

If said first and second members comprise thermoplastic foam and incorporate respective hollow cavities at said first and second welding surfaces, said interposed junction piece comprises side extensions, said side extensions being smaller than said cavities and having shapes complementary to a shape of said cavities.

An assembly may incorporate a plurality of such welded joint structures. The assembly might comprise any of: a truss, a ladder, balustrades, a gate, or another substantially flat strut assembly; a window, a picture frame, a solar collector, or another panel assembly, a door, a garage panel door, a building panel, or another multi-panel assembly; a cupboard, a drawer, a bay window, or another box panel assembly; a table, a chair, patio furniture, or another combined flat panel and strut assembly; and a gazebo, a porch, or another combined three-dimensional multi-strut assembly.

In some embodiments, the junction piece comprises respective welding surfaces for forming vibratory welded bonds between said junction piece and said first and second thermoplastic members, and a component holder, physically coupled to said respective welding surfaces, for enabling said junction piece to hold a further component.

The component holder may comprise a tab that further enables said junction piece to be held in a fixture of a vibratory head during a vibratory welding process by which said vibratory welded bonds are formed.

The component holder may comprise a cavity, defined at least partially by said welding surfaces, for receiving at least a portion of said further component.

The further component itself may be integrated with said junction piece, with said component holder comprising a portion of said junction piece connecting said welding surfaces with said further component.

In some embodiments, said component holder is integrated with an extension of said junction piece beyond said welding surfaces.

The extension may comprise, as said component holder, a cavity for receiving at least a portion of said further component.

The extension is at an angle to at least one of said welding surfaces in some embodiments.

In some embodiments, said extension extends in a direction parallel to at least one of said welding surfaces and comprises an end structure, and said further component comprises a structural support incorporating at least one opening having a shape complementary to said end structure, said end structure enabling said junction piece and said first and second members to be supported by said structural support.

The end structure may further enable said junction piece to be held in a fixture of a vibratory head during a vibratory welding process by which said vibratory welded bonds are formed.

The component comprises at least one compressible seal for sealing a gap between said first and second members in one embodiment.

The component holder may comprise one or more edges of said junction piece, with said further component comprising a flexible rubber seal.

In some embodiments, said component holder comprises an extension of said junction piece beyond said respective welding surfaces, with said extension spacing a connector from one of said first and second members and positioning said connector parallel to a longitudinal length of said one of said members.

An open-ended slot connector is one example of such a connector.

An assembly may incorporate a plurality of welded joint structures having such a junction piece.

Another aspect of the invention provides a method for forming a vibratory welded connection between first and second members and a junction piece, where said members and said junction piece are composed at least in part of thermoplastic material. The method involves providing a junction piece having a first portion for welding to said first and second members, holding said first and second members such that respective welding surfaces of said first and second members are positioned at a predetermined relative position in which at least one of said welding surfaces partially defines an angle, in a plane normal to said at least one welding surface, between an unwelded portion of said first member and an unwelded portion of said second member, creating an engagement force between each of said respective welding surfaces of said first and second members and a respective opposite side of said first portion of said junction piece, maintaining said engagement forces while vibrating said junction piece to create friction generated heat to melt material on said welding surfaces of said members and on each respective opposite side of said first portion of said junction piece, such melted material upon cooling forming a weld between said junction piece and said welding surfaces of said members.

The operation of creating an engagement force may involve applying a mechanical force, in a direction towards said junction piece, on a respective surface of at least one of said first member and said second member that is substantially parallel to said welding surface of said at least one of said first member and said second member.

The method may also include moving said first member and said second member in respective directions toward said junction piece as material is melted at interfaces between said first member and said junction piece and between said second member and said junction piece so as to maintain substantially even pressure at said interfaces.

In some embodiments, the method further includes at least one of: deforming said first member to form its respective welding surface, and deforming said second member to form its respective welding surface.

The operation of vibrating said junction piece may involve vibrating said junction piece in a direction parallel to at least one of said unwelded portion of said first member and said unwelded portion of said second member.

Providing a junction piece may involve providing a junction piece in which said first portion is offset from said second portion relative to a direction of vibration of said junction piece.

A junction piece having an integrated component disposed between said first portion and said second portion could be provided as said junction piece. The integrated component may be at least one of: an end cap for sealing an open hollow end of one of said first member and said second member, where said one of said first member and said second member comprises a hollow profile defined by at least one peripheral wall; a hardware component; and means for carrying a hardware component.

The junction may further comprise a component holder, physically coupled to said first portion, for enabling said junction piece to hold a further component.

The operation of vibrating may involve mounting said component holder to a fixture connected to a vibratory head, and vibrating said junction piece by means of said vibratory head.

In some embodiments, the method includes installing said further component at said component holder.

The junction piece may comprise a removable tab that is held in a fixture during vibration of said junction piece, with said first portion being offset from said removable tab.

The method may also involve determining a dimension of said junction piece, and automatically controlling positions of member fixtures relative to said junction piece based on said determined dimension, said member fixtures being for respectively holding said first and second members.

Where said junction piece comprises a first portion for welding to said first and second members and a second portion extending from said first portion for coupling to a vibratory head, and said first portion and said second portion have a common datum relative to said welded connection, controlling may involve controlling positions of said member fixtures to hold said first and second members at respective predetermined distances from said common datum.

If said junction piece comprises a first portion for welding to said first and second members and a second portion extending from said first portion for coupling to a vibratory head, and said first portion is offset from said second portion such that said first portion has a datum relative to said welded connection and said second portion has a different datum than said first portion, controlling may involve controlling positions of said member fixtures to hold said first and second members at respective predetermined distances from said datum of said first portion.

The junction piece may comprise opposed substantially parallel respective welding surfaces for welding to said first and second members, in which case determining said dimension may involve determining a distance between said welding surfaces.

In some embodiments, determining involves receiving an input of the dimension from a user.

An apparatus is also provided for forming a vibratory welded connection between first and second members and a junction piece, said members and said junction piece being composed at least in part of thermoplastic material. The apparatus comprises a vibratory head, a junction piece fixture, connected to said vibratory head, for holding said junction piece, and respective member fixtures for holding said first and second members such that respective welding surfaces of said first and second members are positioned at a predetermined relative position in which at least one of said welding surfaces partially defines an angle, in a plane normal to said at least one welding surface, between an unwelded portion of said first member and an unwelded portion of said second member, said member fixtures supporting said first and second members for movement independently of said vibratory head.

The apparatus may also include a positioning system operatively coupled to said member fixtures and operable to determine a dimension of said junction piece and to control positions of said member fixtures relative to said junction piece fixture based on said determined dimension.

In some embodiments, said junction piece comprises a first portion for welding to said first and second members and a second portion extending from said first portion, and said junction piece fixture is operable to hold said second portion of said junction piece. If said first portion and said second portion have a common datum relative to said welded connection, and said positioning system may be operable to position said member fixtures to hold said first and second members at respective predetermined distances from said common datum. However, if said first portion is offset from said second portion such that said first portion has a datum relative to said welded connection and said second portion has a different datum than said first portion, said positioning system may be operable to position said member fixtures to hold said first and second members at respective predetermined distances from said datum of said first portion.

The junction piece fixture may be operable to hold a portion of said junction piece that is disposed at a predetermined location relative to said welded connection.

The junction piece fixture may be adjustable to hold a portion of said junction piece that is disposed at any of a plurality of respective different locations relative to said welded connection. For example, where said welded connection comprises top, bottom, front, and rear edges relative to said vibratory head, said junction piece fixture may be adjustable to hold a portion of said junction piece disposed at any of said top, bottom, front, and rear edges of said welded connection.

In some embodiments, said junction piece fixture and said vibration element are disposed relative to each other to provide an in-feed path for feeding said junction piece into said junction piece fixture.

The in-feed path may comprise an area above said junction piece fixture, to form a gravity in-feed for said junction piece for instance.

The junction piece comprises a first portion for welding to said first and second members and a removable second portion extending from said first portion, and the junction piece fixture is operable to hold said second portion of said junction piece in some embodiments. The vibration element and said junction piece fixture may then be disposed relative to each other to provide an out-feed path for feeding said second portion of said junction piece out of said junction piece fixture after said welded connection is formed and said second portion of said junction piece is removed.

The vibration element and said junction piece fixture may be further disposed relative to each other to provide an in-feed path for feeding said junction piece into said junction piece fixture.

The in-feed path comprises a gravity in-feed for said junction piece, and said out-feed path comprises a gravity out-feed for said second portion of said junction piece in some embodiments.

The positioning system may be operable to control relative positions of said member fixtures in a first direction, with said member fixtures being further adjustable in a second direction substantially perpendicular to the first direction.

At least one of said member fixtures comprises a clamping stop in some embodiments.

The member fixtures may hold said first and second members for forming a butt joint as said welded connection.

Where said junction piece comprises opposed substantially parallel respective welding surfaces for welding to said first and second members, said dimension may comprise a distance between said welding surfaces.

The positioning system may comprise a user input device for receiving an input from a user in some embodiments, with the positioning system determining the dimension of said junction piece based on said input.

The apparatus may also include pressure actuators operatively coupled to said member fixtures and operable to provide an engagement force between said first and second members and said junction piece.

In a system for interconnecting a series of elongate frame members to form a closed frame, adjacent ends of adjoining frame members may be engaged as first and second members within a respective apparatus.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1-a is an exploded perspective detail of a vibratory welded corner joint of two elongated thermoplastic members.

FIG. 1-b is a perspective detail of a vibratory welded butt corner joint of two elongated thermoplastic members.

FIG. 2-a are plan view details of cut-lines for a thermoplastic member.

FIG. 2-b are plan view details of the cut waste residue for a butt corner and miter corner joint.

FIG. 2-c are plan view details of a vibratory-welded butt corner joint and a vibratory-welded mitre corner joint.

FIG. 3-a is a perspective view detail of a vibratory welded corner joint with a back-held, two part junction piece with a removable tab.

FIG. 3-b is a cross section detail and elevation view of a vibratory welded butt corner joint and a back-held, two part junction piece with a removable tab.

FIG. 3-c is a cross section detail and elevation view of a vibratory welded butt corner joint and a back-held, two part junction piece with a top attached removable tab.

FIG. 3-d is a cross section detail and elevation view of a vibratory welded butt corner joint and a back-held, two part junction piece with a bottom attached removable tab.

FIG. 4-a is an exploded perspective detail of a vibratory welded butt corner joint of two elongated thermoplastic members with one thermoplastic member incorporating a leg-extension and a second member incorporating a corresponding recess.

FIG. 4-b is an exploded perspective detail of the vibratory welded butt corner joint assembly shown in FIG. 4-a.

FIG. 5 shows an exploded perspective detail of a vibratory welded butt corner joint of two hollow thermoplastic profiles with one profile incorporating a hollow leg extension and the second profile incorporating a corresponding recess.

FIG. 6 shows an exploded perspective view of a vibratory welded butt corner joint of two elongated thermoplastic members with a three dimensional, V-chamfered junction piece.

FIG. 7-a shows an exploded perspective detail view of a vibratory welded T-joint of two elongated thermoplastic members with a bottom held junction piece.

FIG. 7-b shows a perspective view of the vibratory welded T-joint shown in FIG. 7-a.

FIG. 8-a shows an exploded perspective detail view of a vibratory-welded T-joint of two elongated U-channel thermoplastic members with a bottom-held, three-dimensional, V-chamfered junction piece.

FIG. 8-b shows a cross sectional detail of the vibratory welded T-joint shown in FIG. 8-a.

FIG. 9-a shows an exploded perspective view of two elongated thermoplastic members that are vibratory welded with a scarf joint using a flat strip junction piece.

FIG. 9-b shows a cross sectional detail of the scarf joint shown in FIG. 9-a.

FIG. 10-a shows an exploded perspective view of two elongated thermoplastic members vibratory welded together with a mortice-and-tenon joint using a U-shaped, side-held junction piece.

FIG. 10-b shows a cross sectional detail of the mortice-and-tenon joint shown in FIG. 10-a.

FIG. 11-a shows an exploded perspective view of elongated thermoplastic members vibratory welded to opposite bottom end corners of a third elongated member using flat strip junction pieces.

FIG. 11-b shows a cross sectional plan view of the two vibratory welded corner butt joints shown in FIG. 11-a.

FIG. 11-c shows an elevation view of the two vibratory welded corner butt joints shown in FIG. 11-a.

FIG. 12-a shows a perspective detail of three parallel elongated thermoplastic members vibratory welded to a fourth perpendicular thermoplastic member.

FIG. 12-b shows an exploded perspective detail of a vibratory T-joint between one of the parallel elongated members and the fourth perpendicular member of FIG. 12-a.

FIG. 13 shows an elevation detail of a vibratory welded corner butt joint of two thermoplastic members with a decorative, curved corner brace vibratory welded to the two inner side surfaces of the thermoplastic members.

FIG. 14 shows an elevation view of a roof truss incorporating a series of different types of vibratory welded joints.

FIG. 15 is a partially exploded perspective view of decorative cut-out thermoplastic sheet panels joined at the top and bottom side corners using vibratory-welded butt joints.

FIG. 16-a is a perspective view of a three dimensional junction piece incorporating a series of V-chamfered recesses.

FIG. 16-b is a cross sectional detail of a joint structure including the three dimensional junction piece shown in FIG. 16-a.

FIG. 17-a is a perspective view of a flat strip junction piece incorporating compression seals on its side edges.

FIG. 17-b is a perspective view of a butt joint incorporating a compression seal.

FIG. 18-a is an exploded perspective view of the end face of a thermoplastic elongated member vibratory welded to the side face of a thermoplastic component member.

FIG. 18-b is a cross section detail of the vibratory welded joint shown in FIG. 18-a.

FIG. 19-a is an exploded perspective view of a vibratory welded butt joint with a diamond shape junction piece.

FIG. 19-b is an elevation view of the vibratory welded butt joint shown in FIG. 19-a.

FIG. 20-a shows an exploded perspective butt joint detail of two elongated thermoplastic members that are vibration welded together using a junction piece that incorporates a hollow cavity for holding a further component.

FIG. 20-b shows a side elevation view detail of a vibration welded corner butt joint assembly shown in FIG. 20-a.

FIG. 21-a shows a perspective detail of a vibration welded corner butt joint incorporating a junction piece with a perpendicular back edge extension as a component holder.

FIG. 21-b shows a side elevation view of the corner butt joint shown in FIG. 21-a.

FIG. 22-a shows a partially exploded perspective detail of a vibration welded corner butt joint incorporating a junction piece with a dual function back edge extension.

FIG. 22-b shows a perspective detail of a vibration welded corner butt joint as shown in FIG. 22-a.

FIG. 22-c shows an elevation view of a panel assembly formed using joints as shown in FIG. 22-b.

FIG. 23-a is an exploded perspective view of a vibration welded corner butt joint featuring an indented U-channel corner key.

FIG. 23-b is an elevation view of the vibratory welded corner butt joint shown in FIG. 23-a.

FIG. 24 shows a perspective view of a one head vibration corner welder used for manufacturing corner butt welds.

FIG. 25-a is a plan view of the vibration corner welder shown in FIG. 24 with the equipment in an open position configured to fabricate butt joints as shown in FIGS. 1 to 19.

FIG. 25-b is a plan view of the vibration corner welder shown in FIG. 24 with the equipment in a weld cycle and configured to fabricate butt joints as shown in FIGS. 1 to 19.

FIG. 26-a is a plan view of the vibration welder shown in FIG. 24 with the equipment in an open position and configured to fabricate butt joints incorporating a component holder as shown in FIGS. 20 to 22.

FIG. 26-b is a plan view of the vibration welder shown in FIG. 24 with the equipment in a weld cycle and configured to fabricate butt joints incorporating a component holder as shown in FIGS. 20 to 22.

FIG. 27 shows an elevation view of the vibration corner welder shown in FIG. 24.

### DETAILED DESCRIPTION OF PREFERRED EMBODIMENTS

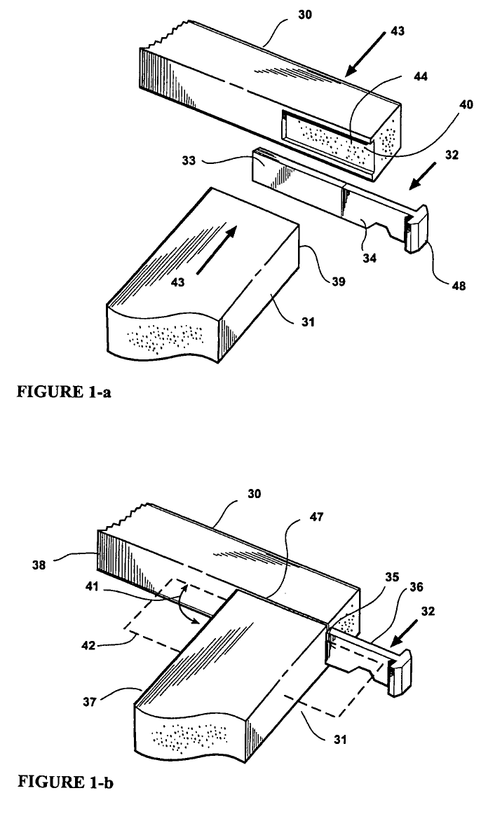

FIG. 1-a is an exploded perspective detail of a vibratory welded butt corner joint of two thermoplastic members 30 and 31. An interposed junction piece 32 is vibratory welded to a welding surface 39 that is parallel to the end surface of the member 31 and to a welding surface 40 that is parallel to the side surface of the member 30. The junction piece 32 consists of two portions 33 and 34. The first portion 33 is interposed between the two thermoplastic members 30 and 31 and the second portion 34 allows for the junction piece 32 to be held firmly in position and withstand the high G-forces that occur during the vibration welding process. To allow the junction piece to be firmly held in the clamping device, the second portion 34 incorporates a geometric shape feature and with as one example being a T-shaped, extension 48 as shown in FIG. 1-a. The second portion 34 may be a removable tab, although the second portion can be incorporated as a feature of the final product assembly of the thermoplastic members.

During the vibration welding process, substantially perpendicular even pressure, represented in FIG. 1-a by 43, may be applied on both sides of the junction piece 32. The side face of the member 30 can incorporate a channel recess 44 and the end face of the member 30 can also incorporate a complementary channel recess (not shown). In combination, these channel recesses provide the option for the junction piece 32 to be relatively thick. For certain materials, this thickness may be advantageous in order to provide the junction piece 32 with sufficient stiffness and rigidity to prevent elastic movement during the vibration welding process. The channel recesses may also help to hide the flash (melted plastic) generated during the vibration welding process. Since the edges of the members are not welded at the joint line 47 (FIG. 1-b), this results in a thin joint line that is visually attractive.

As shown in FIG. 1-b, the two thermoplastic members 30 and 31 are vibratory welded to opposite and substantially parallel surfaces 35 and 36 of the interposed junction piece 32 at the first and second welding surfaces 39 and 40. The welding surfaces partially define an angle 41 in a plane (shown by a dotted line 42) that is normal to the junction piece 32 between the unwelded portions 38 and 37 of the thermoplastic members 31 and 32.

The thermoplastic members 30 and 31 and the junction piece 32 may be made from the same plastic material, although different thermoplastic materials can be used as long as the three components can be welded together through the thermal melting process. The thermoplastic members can be made a wide range of different thermoplastic materials and the thermoplastic members can be solid, foam, composite and/or hollow profiles.

The two thermoplastic members 30 and 31 can be produced through various plastic processing methods including extrusion, pultrusion, roll-forming and blow-molding. The interposed thermoplastic junction piece 32 can also be produced through various plastic processing methods including injection molding, extrusion and roll-forming.

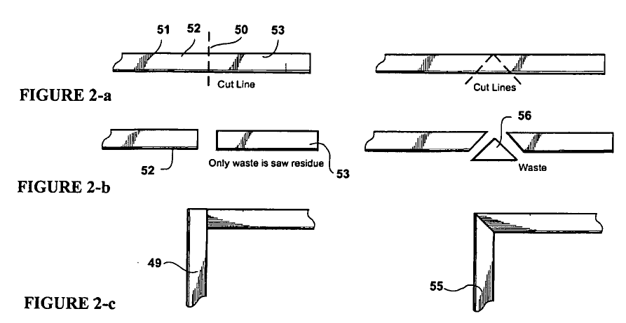

FIG. 2-a shows a plan view of a single cut line 50 for a vibratory welded corner butt joint where the two cut portions 52 and 53 of a length 51 of thermoplastic material are used to produce a vibratory welded butt corner joint 49 as shown in FIG. 2-c. In comparison, two miter cut lines are required to produce a vibratory welded miter corner shown in FIG. 2-c. As illustrated in FIG. 2-b, the single cut-line required for a corner butt joint 49 produces only saw residue while the double miter cuts required to produce a miter cut joint 55 produces significantly more cutting waste 56 in addition to more saw residue due to multiple cuts.

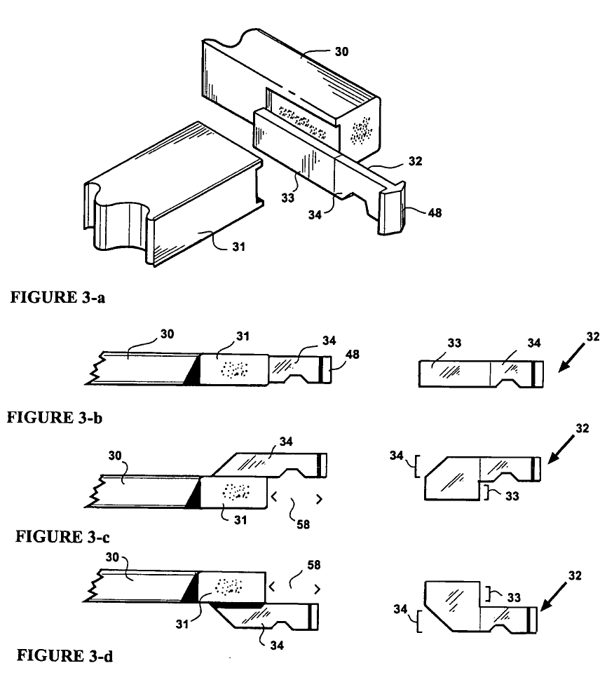

FIG. 3-a shows a plan view detail of a butt corner joint where two thermoplastic members 30 and 31 are vibratory welded to a junction piece 32. The junction piece 32 consists of two portions 33 and 34. The first portion 33 is vibratory welded to the two thermoplastic members 30 and 31 while the second portion 34 is held in a web clamping device during the vibration welding process. The second portion 34 may be a tab that is removed following the vibratory welding process, for example. To allow the junction piece 32 to be held firmly during the welding process, the second portion 34 may incorporate some holding means and one possible option is a T-shaped extension 48.

In FIG. 3-b, the removable tab 34 extends out from the back edge of the first portion 33 of the junction piece 32. Alternatively, as shown in FIGS. 3-c and 3-d, the removable tab 34 can extend out from the top or bottom edge of the first portion 33 of the junction piece 32, and thereby be offset from the first portion 33 relative to a direction of vibration of the junction piece 32.

It should be noted that in all three cases shown in FIG. 3-a, FIG. 3-b, and FIG. 3-c, the junction piece 32 is held at the back and vibrated back and forth, as shown at 58.

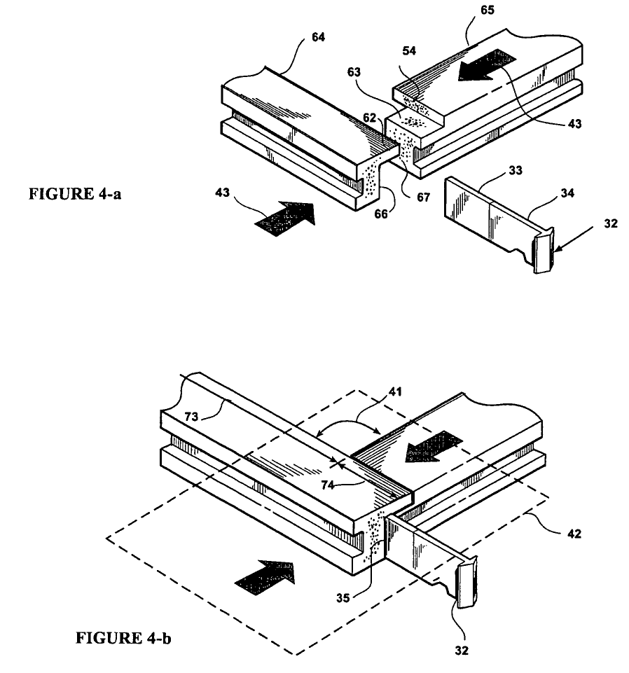

FIG. 4-a is an exploded perspective detail of a vibratory welded butt corner joint of two elongated L-shaped thermoplastic members 64 and 65 where one of the elongated thermoplastic members incorporates a leg extension 62 and part of the other member is removed to create a corresponding recess 63. The first portion 33 of the junction piece 32 is welded to the partial side face 66 of the member 64 and the partial end face 67 of the member 65. It should be noted that the leg extension 62 might not be welded to side face 54 of the recess 63.

For thermoplastic members, one possible material is foam and this is because of the material cost savings as well as improved visual appearance due to no visual flash. Visual flash is controlled during the vibratory welding process for foam since the flash material produced is largely absorbed into the voids within the plastic foam material. A further advantage is that during the vibratory welding process, the cut foam surfaces offer less friction resistance and as a result, the weld time is reduced.

FIG. 4-b shows a perspective detail of the final assembly of a vibratory welded butt corner joint. The welding surfaces partially define an angle 41 in a plane 42 that is normal to the junction piece 32, between unwelded portions of the members 64 and 65. A single member, and even the same face of one member, may incorporate both welded and unwelded portions as shown by the dividing line between the unwelded and welded portions 73 and 74 of the member 64.

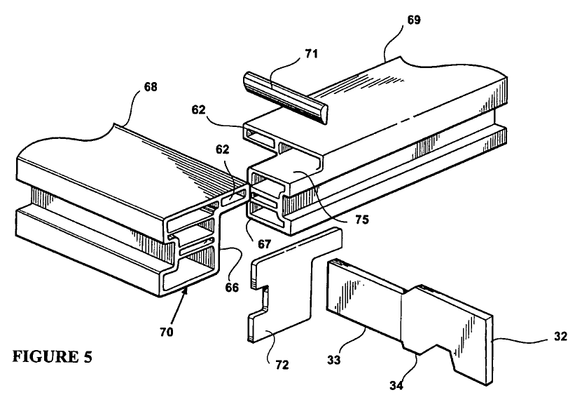

FIG. 5 shows an exploded perspective detail of a vibratory welded butt corner joint of two L-shaped thermoplastic hollow profiles 68 and 69 where one of the profiles 68 incorporates a hollow cavity leg extension 62 and part of the second profile 69 is removed to expose a cavity wall 75.

As with the solid or foam profiles shown in FIG. 4, the first portion 33 of the junction piece 32 is welded to the partial side frame 66 of the hollow profile 68 and the partial end face 67 of the hollow profile 69. Because the leg extension 62 does not weld to the cut-away end face 75 of the profile 69, there is the option of sealing the open joint with a compressible seal 71. An end cap 72 may also be provided to cover or seal the end 70 of the member or profile 68. The end cap 72 may be a separate element, as shown, or integrated with the junction piece 32.

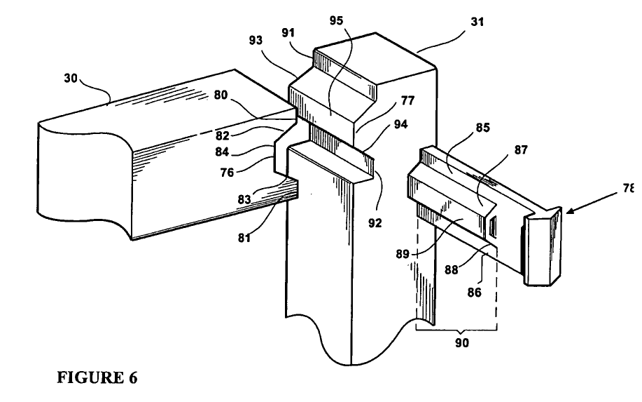

FIG. 6 shows an exploded perspective view of vibratory welded butt corner joint of two elongated thermoplastic members 30 and 31 with the end face of the member 30 being welded to the side face of the member 31. A three dimensional junction piece 78 is used with multiple surfaces being welded to provide for enhanced strength. A chamfered V-channel 76 is machined from the end face of the profile 30 and a complementary chamfered V-protrusion shape 77 is machined from the side face of the profile 31. A three dimensional junction piece 78 is located between the end and side faces of the members 30 and 31 and the junction piece also features a complementary chamfered V-channel structure.

During the vibration welding process, the junction piece 78 is vibrated back and forth and the multiple end faces, junction piece faces and side faces are welded together. The multiple end faces of member 30 include top and bottom end faces 80 and 81, sloped channel sides 82 and 83, and bottom channel surface 84. The complementary top surfaces of the three dimensional junction piece 78 include top and bottom end faces 85 and 86, sloped sides 87 and 88 and top protrusion surface 89. Thus, the member 30 has multiple first welding surfaces over the length 90 of a first portion of the junction piece 78. Similarly, the member 31 has multiple second welding surfaces, including top and bottom side faces 91 and 92, sloped protrusion side faces 93 and 94 and the top protrusion surface 95, for welding to the complementary surfaces (not shown) on the back face of the junction piece.

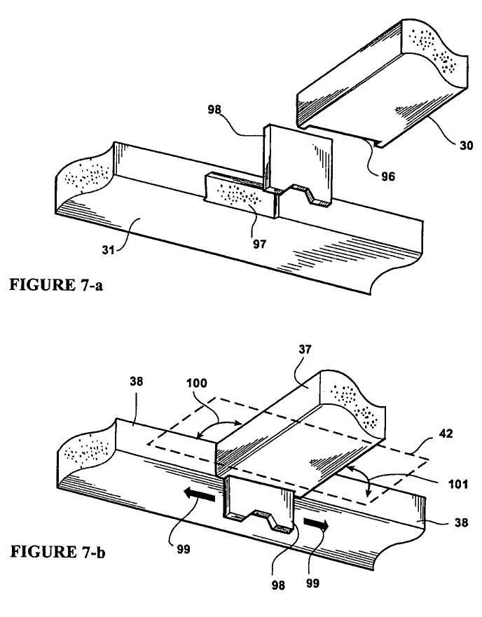

FIG. 7-a shows an exploded perspective detail view of a vibratory welded T-joint where the end face of a first thermoplastic member 30 is welded to the side face of a second thermoplastic member 31. To accommodate a bottom held junction piece 98, two recesses 96 and 97 are machined out of the end face and the side face of the members 30 and 31.

FIG. 7-b shows a perspective view of the welded T-joint. During the vibration welding process, the bottom held junction piece 98 is vibrated side-to-side as shown at 99, and the junction piece is welded to the bottom surfaces of the two channel recesses 96 and 97, which bottom surfaces form first and second welding surfaces. Each of these welding surfaces at the bottom of the channel recesses 96 and 97 partially defines the angles 100 and 101, in a plane 42 that is normal to the junction piece 98, between the unwelded portions 37, 38 of the members 30 and 31. Because the member 30 is welded perpendicular to the member 31, both angles 100 and 101 are 90°.

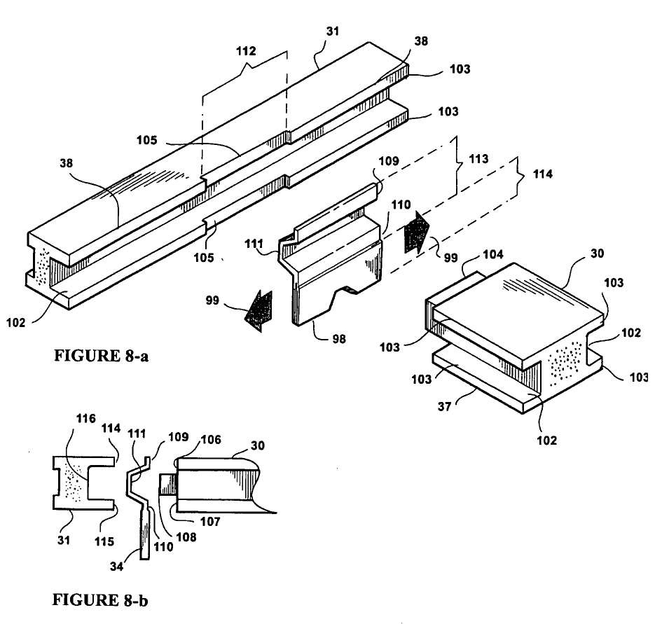

FIG. 8-a shows an exploded perspective view of a vibratory welded T-joint of two elongated thermoplastic members where the end face of one thermoplastic member 30 is welded to the side face of another thermoplastic member 31. The member 30 incorporates two U-channels 102 on its opposite sides, while the member 31 incorporates a single U-channel 102. The two members are welded together using a bottom held, three dimensional, U-channel junction piece 98 that is vibrated side-to-side, as shown at 99.

To provide for a strong structural joint, both members 30 and 31 are machined so that in combination a mortice-and-tenon joint is formed. For the member 30, the leg extensions 103 of both U-channels 102 are fully removed creating a protrusion 104. For the second member 31, two recesses 105 are out machined out the two leg extensions 103. During the vibratory welding process, the bottom held junction piece 98 is vibrated side to side and the multiple end surfaces of the member 30, including leg end faces 106 and 107 and the protrusion end face 108 are welded to the complementary surfaces 109, 110, and 111 of the U-channel junction piece (See cross section detail as shown in FIG. 8-b). These multiple first welding surfaces are welded to corresponding welding surfaces of the welding portion 113 of the junction piece 98. Similarly, the multiple second welding surfaces of the member 31, including leg end faces 114 and 115 and channel end face 116 are welded to the complementary faces of the three dimensional U-channel junction piece 98 in the area generally designated in FIG. 8-a by the dimensional line 112. It should be noted that the dimension line 114 indicates the area of a removable tab 34 of the junction piece 98.

With conventional vibration corner welding, miter cut, U-channel profiles can be preassembled around a single panel and the corner joints can then be welded with the panel in position. With vibratory welded T-joints, U-channel profiles can be preassembled around multiple panels and the corner joints can then be welded with the multiple panels in position. Generally, this capability of pre-assembling and welding multiple panel assemblies provides for efficient, high volume custom production of multi-panel assemblies such as simulated heritage doors.

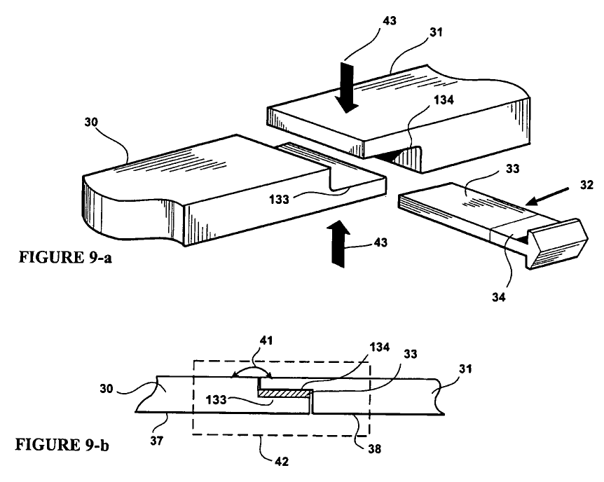

FIG. 9-a shows an exploded perspective view of two elongated thermoplastic members 30 and 31 with overlapping leg extensions that are vibratory welded together using a flat strip junction piece 32. During the vibratory welding process, perpendicular pressure 43 is applied and the back held junction piece 32 is vibrated back and forth creating welds at first and second welding surfaces 133 and 134 of the members 30 and 31.

FIG. 9-b shows a cross sectional detail of the scarf joint shown in FIG. 9-a. The two welding surfaces 133 and 134 each partially define an angle 41 in a plane 42 that is normal to the junction piece 32 between the unwelded portions 37 and 38 of the first and second members 30 and 31. In the case of a scarf joint, the angle 41 between the unwelded portions 37 and 38 is 180°.

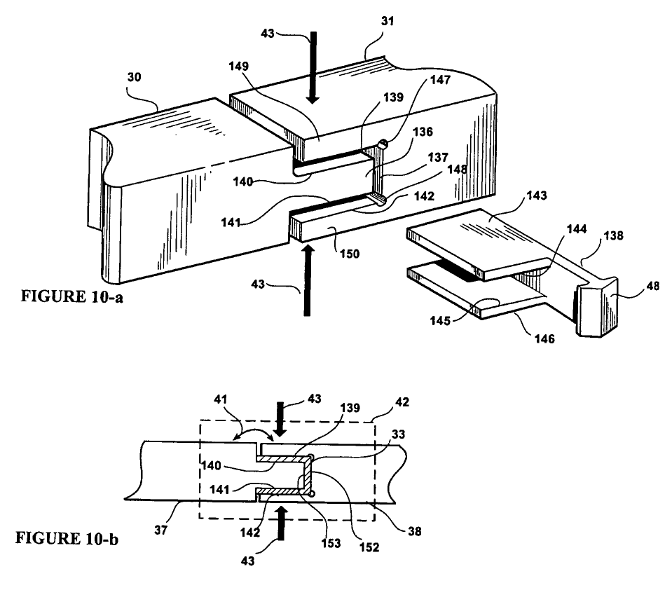

FIG. 10-a shows a partially exploded perspective view of two thermoplastic members 30 and 31 vibratory welded together using a U-shaped, back-held junction piece 138. The end faces of the members 30 and 31 are machined to form a protrusion 136 and a channel recess 137. During the vibratory welding process, perpendicular pressure 43 is applied and the back held, U-channel junction piece is vibrated back-and-forth so that the overlapping surfaces 139, 140, 141, and 142 of the thermoplastic members 30 and 31 are welded to the surfaces 143, 144, 145, and 146 of the U-channel junction piece 138. In combination, these multiple welded surfaces form the equivalent of a mortice-and-tenon joint.

As shown in the cross section detail FIG. 10-b, the multiple welding surfaces partially define an angle 41, in a plane 42 that is normal to the welding portion 33 of the junction piece 32, between the unwelded portions 37 and 38 of the first and second members 30 and 31. In the case of the mortice-and-tenon joint, the angle 41 between the unwelded portions 37 and 38 is 180°.

It should be noted that to allow for pressure to be applied to the junction piece 32, the corners of the channel recess may incorporate pivot points 147 and 148 so that the leg extensions 149 and 150 can flex downwards. Although not shown, if perpendicular pressure is simultaneously applied longitudinal along the length of the members 30 and 31, the channel and protrusion surfaces 152 and 153 can also be welded to the junction piece.

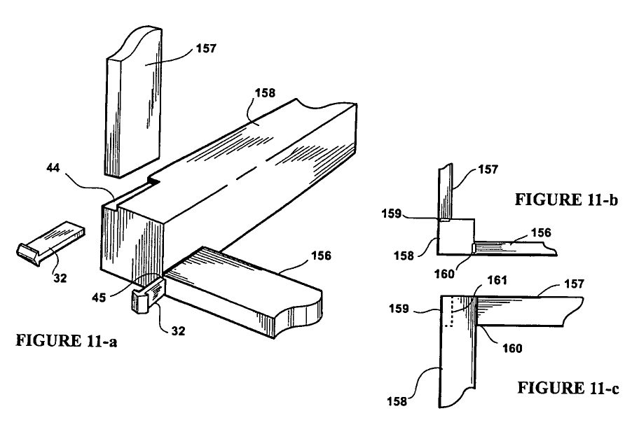

FIG. 11-a shows an exploded perspective view of two elongated members 156 and 157 vibratory welded to opposite end corners of a third elongated member 158. Channel recess 44, 45 are formed in the member 158 in order to accommodate the back held, flat strip junction pieces 32. FIG. 11-b shows a cross section plan view of the two corner butt welded joints 159 and 160 shown in FIG. 11-a. FIG. 11-c shows a cross section plan view of the two corner butt corner welded joints 159 and 160 shown with the second vibratory butt weld joint being indicated by a dotted line 161.

Generally, this capability of producing three dimensional multi-strut assemblies illustrated in FIG. 11 is an advantage of the vibrating welding corner joint technology proposed herein, and allows for a variety of different products to be fabricated from thermoplastic extrusions, including: tables, chairs, and patio furniture, for example.

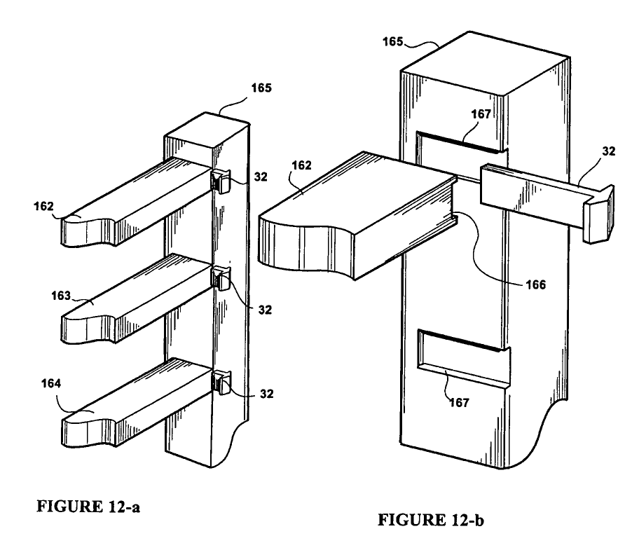

FIG. 12-a shows a perspective view of three parallel horizontal elongated thermoplastic members 162, 163, 164 to be vibratory welded to a fourth vertical elongated thermoplastic member 165. The vibratory welded T-Joints are formed using back-held junction pieces 32.

FIG. 12-b shows an exploded perspective detail of the vibratory welded T-joint between the horizontal elongated member 162 and the vertical elongated member 165. To accommodate the flat strip junction piece 32, channel recesses 166 and 167 are formed in the end face 39 of the horizontal member 162 and the side face 40 of the vertical member 165.

Generally, this capability of producing two dimensional strut assemblies is an advantage of the vibratory welding corner joint technology proposed herein, and allows for a variety of different products to be fabricated from thermoplastic extrusions including: balustrades, ladders, and roof trusses, for instance.

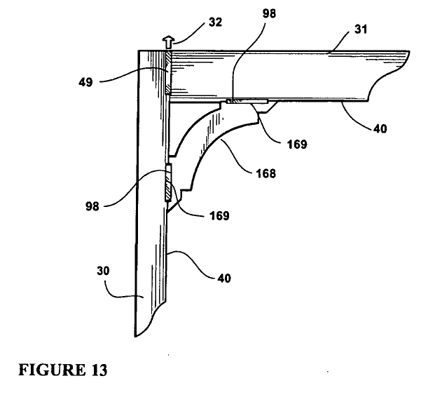

FIG. 13 shows an elevation detail of a vibratory welded corner butt joint 49 of two elongated thermoplastic members 30 and 31 and where a decorative, curved corner brace component 168 is vibratory welded to the inner side surfaces 40 of the thermoplastic members 30 and 31. The corner butt joint 49 is formed using a back-held junction piece 32. The decorative corner brace component 168 may be injection molded and incorporate channel recesses with complementary channel recesses also formed on the side faces 40 of the members 30 and 31. To weld the side faces 40 of the thermoplastic members 30 and 31 to the side faces 169 of decorative component 168, a bottom-held junction piece 98 that is vibrated side-to-side may be used.

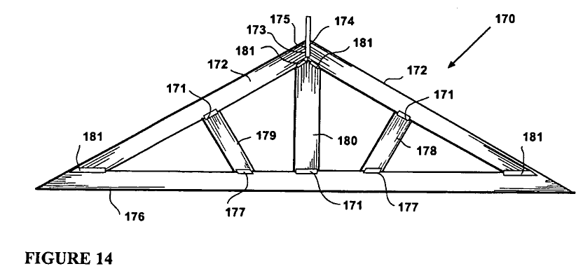

FIG. 14 shows an elevation view of a roof truss 170 fabricated using a number of different types of vibratory welded joints. The miter cut ends 173 and 174 of sloped thermoplastic members 172 are joined at the apex using a vibration corner welding miter joint. The end faces of the structural braces 178, 179, 180 are vibratory welded to the side faces of the sloped thermoplastic members 172 and horizontal thermoplastic member 176 using vibratory welded T-joints 171 and inclined angle corner butt joints 177, 181. Finally, the end faces of the sloped thermoplastic members 172 are also welded to the side face of the horizontal member 176 using inclined-angle corner butt joints 181.

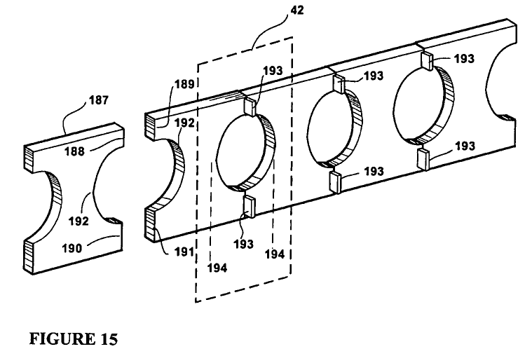

FIG. 15 is a partially exploded perspective view of thermoplastic sheet panels 187 incorporating cut outs 192 and joined at the top and bottom side corners 188, 189, and 190, 191 using vibratory welded butt joints. The two welding surfaces on either side of a junction piece 193 partially define an angle, in a plane 42 normal to the junction piece, between unwelded portions of the two thermoplastic panels indicated by the dotted lines 194.

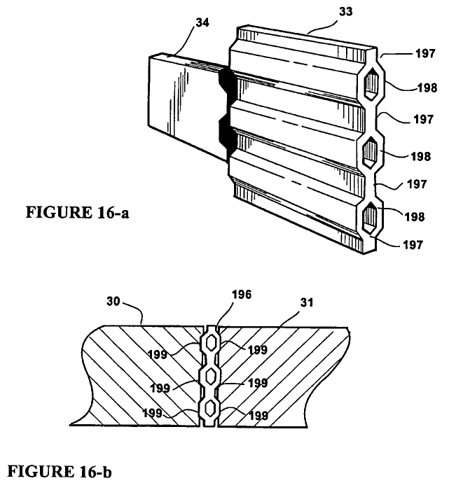

FIG. 16-a shows a perspective view of a three dimensional thermoplastic junction piece with the first portion 33 of the junction piece consisting of a series of hollow welded chamfered V protrusions 198 and corresponding matched channel recesses 197 on each side of the junction piece. The second portion 34 of the junction piece is a removable tab that allows the junction piece to be firmly clamped in position during the vibration welding process.

FIG. 16-b is cross section detail of the three dimensional thermoplastic junction piece 196 of FIG. 16-a that is welded to first and second thermoplastic members 30 and 31. V-chamfered grooves are machined into the end surfaces of the thermoplastic members. During the vibration welding process, the junction piece 196 is vibrated back and forth and the V-chamfered protrusions weld to the surfaces of the members 30 and 31 at 199, but leave a series of unwelded voids. This has the advantage that the available welding surface is reduced and as a result, the vibration power required to weld the members is correspondingly reduced, allowing for large cross section thermoplastic members to be welded together.

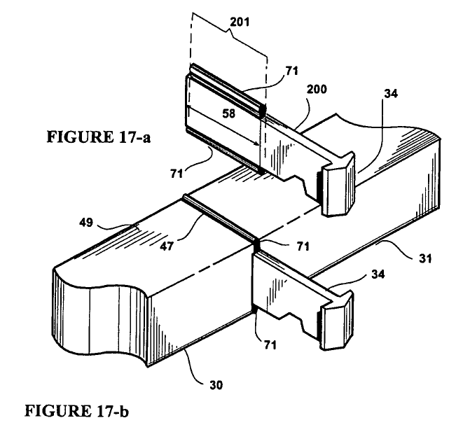

FIG. 17-a is a perspective view of a flat strip junction piece 200 incorporating a removable tab 34 and compression seals 71 on the two side edge surfaces of the junction piece 200. The compression seals 71 are made from flexible, rubber-like materials with one preferred option being flexible PVC that is bonded to the edge of the junction piece 200 during the manufacturing process of the junction piece. During the vibration welding process, the junction piece 200 is vibrated back and forth, but because the compression seals are made from flexible material, no friction is created and the compression seals do not bond to the thermoplastic members 30 and 31. The dimension line 201 indicates the length of the first portion of the junction piece that is welded to the thermoplastic members during the vibration welding process.

FIG. 17-b is a perspective view of a vibration welded butt joint 49 of the first and second thermoplastic members 30 and 31. During the vibration welding process, the two thermoplastic members 30 and 31 are pressured against the junction piece 200. As previously mentioned, because the compression seals 71 are made from flexible material, the seals do not weld to the thermoplastic members 30 and 31 but the seals 71 are compressed and then permanently held in position.

One advantage of the compression seals 71 is that the open joint along the edge of the junction piece 200 is sealed and this prevents moisture from entering the joint line 47. This can be important when moisture-sensitive thermoplastic materials such as wood fiber-filled PVC materials are used for fabricating the thermoplastic members 30 and 31.

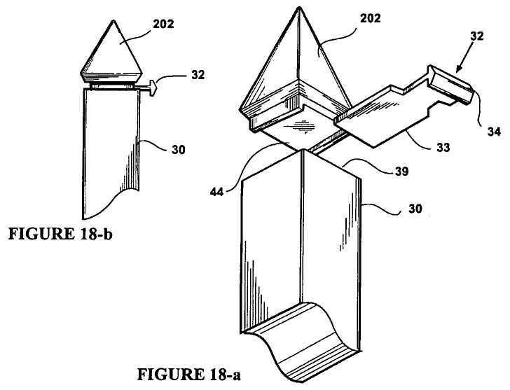

FIG. 18-a is an exploded perspective view of the end face 39 of an elongated thermoplastic member 30 vibratory welded to the side surface of a decorative thermoplastic component member 202 incorporating a channel recess 44. During the vibratory welding process, the junction piece 32 is vibrated back and forth and the end face 39 of the thermoplastic member 30 is welded to the first portion 33 of the junction piece 32 and the side surface 40 of the decorative thermoplastic component member 202 is also welded to the first portion 33 of the junction piece 32.

FIG. 18-b is an elevation detail of a vibratory welded, end-to-side butt joint where an end face of a thermoplastic member 30 is welded to the side surface of a thermoplastic component 202 using the junction piece 32.

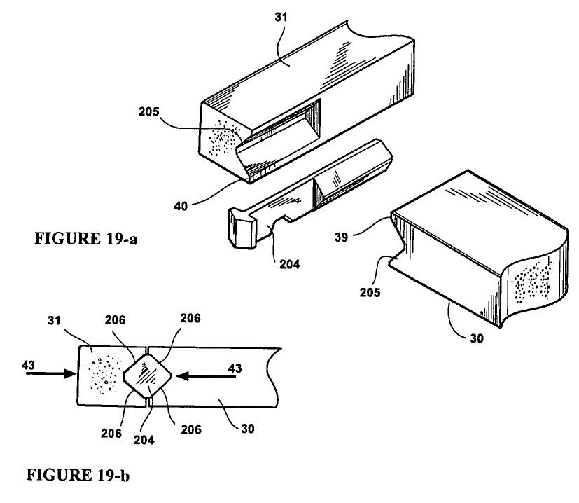

FIG. 19-a is an exploded perspective view of a vibratory welded corner butt joint where an end face 39 of a thermoplastic member 30 is welded to the side surface 40 of a second thermoplastic member 31 using a diamond-shaped junction piece 204. To accommodate the diamond-shaped junction piece 204, V-channels 205 are machined out of the end face 39 and side surface 40 of the thermoplastic members 30 and 31.

FIG. 19-b is an elevation view of the vibratory welded joint shown in FIG. 19-a. It should be noted that during the vibration welding process, because of the diamond shape of the junction piece 204, even triangular pressure is applied to the sloped welding surfaces 206 which are at an inclined angle to the perpendicular pressure 43. In this case, a bottom or innermost surface of the V-shaped channel 205 of the member 31 partially defines an angle between unwelded portions of the members 30 and 31 in a plane normal to a corresponding surface of the junction piece 204.

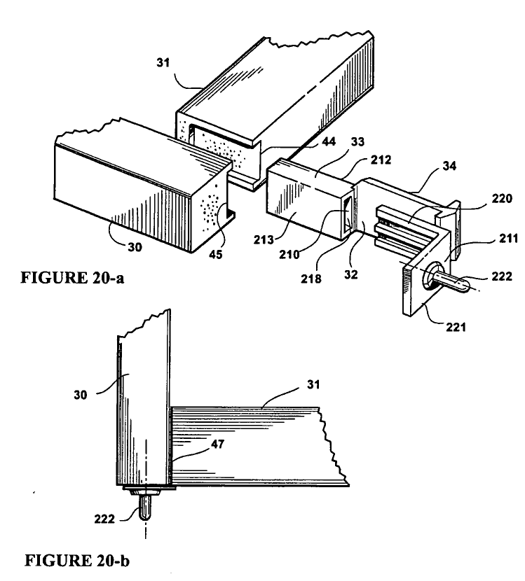

FIG. 20-a shows an exploded perspective detail of a corner joint of two thermoplastic member 30 and 31 that are vibration welded together using a interposed junction piece 32 that includes a first portion 33 that is welded to the thermoplastic members 30 and 31 and a second portion or tab 34 that is firmly held in a vibration welding clamping fixture (not shown). To allow for a further hardware component such as an attachment device to be installed following the welding process, the first portion 33 of the junction piece 32 incorporates a component holder 210 that is integrated with and physically coupled to the welding element 32. As shown in FIG. 20-a, the component holder 210 includes a single longitudinal hollow cavity 218 located on the back edge of the first portion 33 of the junction piece 32. More generally, instead of including a single cavity, the component holder can include multiple cavities and/or other structures such as one or more holes, indents, voids etc. The hollow cavity 218 can also have any cross sectional shape and can be centered or off-centered in the junction piece.

To accommodate an extended overall width of the junction piece 32, channel recesses 45 and 44 are formed in the side and end surfaces of the first and second members 30 and 31. The side welding surfaces 212 and 213 of the first portion 33 of the junction piece 32 are welded to channel recesses 44 and 45 formed in the side face of the first member 30 and the end face of the second member 31. The side edges of the junction piece 32 may also be partially bonded to the side edge surfaces of the channel recesses due to flash flow and limited pressure contact during the friction welding process. As a result, the component holder 210 is firmly held in position at the junction of the thermoplastic members 30 and 31. In addition, the hollow construction and extended overall width of the first portion 33 of the junction piece 32 also provides for increased stiffness and rigidity and this allows the junction piece 32 to handle the high forces that are experienced during the vibration welding process.

After the vibration welding process is complete, the second portion or tab 34 can be removed and this provides clearance so that there is no obstruction when inserting a further component 211 into the component holder 210. This further component 211 can be made from a variety of materials, including but not limited to metals such as aluminum, steel, brass, and/or nickel, and plastics such as thermoplastics, thermosets, and/or composites. The further component 211 incorporates a centering element 220 and in some embodiments, the component holder 211 incorporates complementary centering means (not shown) that allow the further component 211 to be accurately positioned and held within the component holder 210. In addition, the further component 211 can be connected to the component holder 210 through pressure fit attachments, adhesives, sealants and/or other bonding systems.

The further component 211 can also incorporate various hardware features such as a pivot attachment 210 that can support and connect a frame assembly constructed from one or more joints as shown in FIG. 20-a to an outer assembly (not shown). The pivot attachment 222 can be centered on the second member 31 or offset in multiple directions to allow the further component 211 to carry out various other positioning and fastening functions. The hardware component 28 can also incorporate a cover or cap 221 that can protect the exposed end surface of the thermoplastic member 30. This may be particularly useful for composite thermoplastic materials that can be damaged by moisture or other environmental conditions, such as wood fiber filled Polyvinyl Chloride (PVC) materials.

Due to the large, dynamic structural loads and moments involved with conventional window hardware systems, a pivot attachment is typically fixed and anchored to a hollow or solid profile thermoplastic member using metal screws or other fastening systems. In comparison, thermoplastic foam materials are generally quite soft and so these materials typically cannot easily hold conventional screws and fastening systems in position. However by using an intermediary thermoplastic junction piece 32, these attachment problems with foam materials can be overcome. First, the point load from the pivot attachment 222 is spread out and supported by the larger area of the thermoplastic junction piece 32 and second, the structural load and moment imposed by the junction piece is also spread out over a larger area of foam material. The hollow structure of the junction piece 32 also helps resist the torsional loads applied by the hardware attachment. Since the junction piece 32 is sandwiched between thermoplastic members 30 and 31, these loads are effectively transferred to and resisted by the entire welded corner junction assembly.

FIG. 20-b shows a side elevation view detail of the vibration welded corner butt joint assembly as shown in FIG. 20-a. Because the thermoplastic members 30 and 31 overlap the vibration junction piece 32, a thin line butt joint 47 is created.

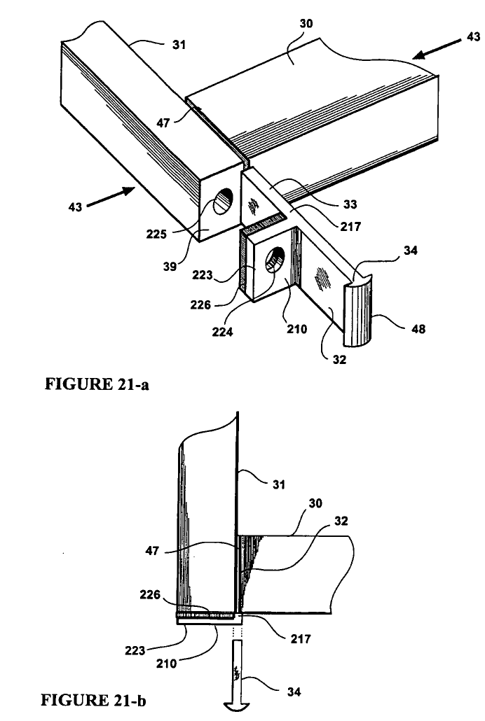

FIG. 21-a shows a partially exploded perspective detail of a vibration welded corner butt joint that is also similar to the vibration welded joint shown in FIG. 20-a but with a further alternative configuration of the component holder 210. In this case, the component holder 210 is a hole 224 incorporated into a perpendicular extension 223 to the back edge 217 of the first portion 33 of the junction piece 32.

The hole 224 allows for the insertion of various hardware attachment devices (not shown) and a complementary hole 225 may thus be fabricated in the end face 39 of the thermoplastic member 31, as this allows for a protrusion attachment device to be more firmly supported.

The perpendicular back edge extension 223 has the same shape as the end face 39 of the thermoplastic member 31 in the embodiment shown in FIG. 21-a. To prevent damage of the exposed end face thermoplastic material of the member 31, compressible material 226 may be laminated to the back face of the perpendicular back edge extension 223. Following the fabrication of a friction welding corner joint, sufficient pressure can be maintained on the compressible material so that the end face 39 of the thermoplastic member 31 is effectively sealed.

FIG. 21-b shows a side elevation view of the completed vibration welded corner butt joint as shown in FIG. 21-a. The perpendicular back edge extension 223 of the junction piece 32 covers the end face 39 of the thermoplastic member 31 and the compressed material 226 prevents moisture and/or other environmental conditions from damaging the thermoplastic end face material. The second portion 34 of the junction piece 32 is removed, providing for a clean visual finish appearance.

The configuration of the component holder shown in FIG. 21-a can be male or female. In the case of a male configuration, a profile cap, represented in FIG. 21-a as the back edge extension 223, may incorporate some form of protrusion that can be inserted into a hollow attachment device. This protrusion may be an integral part of the junction piece or may be a screw or bolt, for example, that is attached to the perpendicular back edge extension 223.

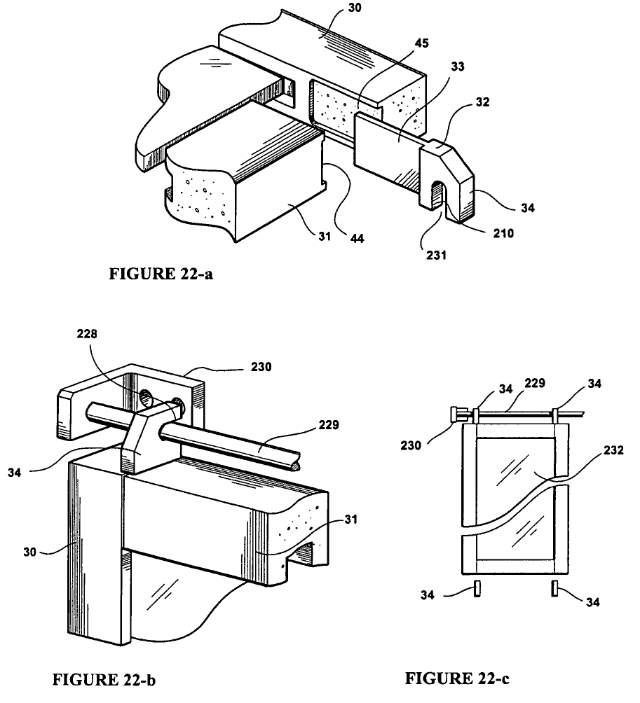

FIG. 22-a shows a partially exploded perspective detail of a vibration welded corner butt joint similar to the vibration welded joint shown in FIG. 20-a but with an alternative configuration of the component holder 210. In this case, the component holder 210 is the second portion 34 of the junction piece 32, which incorporates a bottom edge slot 231. The bottom edge slot 228 allows for the junction piece 32 to be clamped and held in position during the vibration welding process. As noted above, the second portion 34 of the junction piece 32 may be removed following the vibration welding process but in this case, the second portion 34 remains in place and is used as an attachment device for a welded joint or frame assembly.

FIG. 22-b shows a perspective detail of the vibration welded butt joint corner that forms part of a frame assembly where the frame assembly is attached to a rod 229 that is inserted into a bottom edge slot 228 incorporated into the second portion 34 of the junction piece 32. The rod 229 is held in position by means of a support bracket 230. Although the further component illustrated in FIG. 22-b is a rod, alternative attachment component options can also be used, including: static line, ring, hoop, etc.

FIG. 22-c shows an elevation view of a panel assembly 232 that incorporates joints as shown in FIGS. 22-a and 22-b. Since the panel assembly shown in FIG. 22-c is hung from the rod 229 at its top corners, the second portions 34 of the junction piece 32 are removed at the two bottom corners of the panel assembly 232. However for the top two corners, the second portions 34 of the junction piece 32 are not removed and as previously explained, are used to help hold the panel assembly 232 in position.

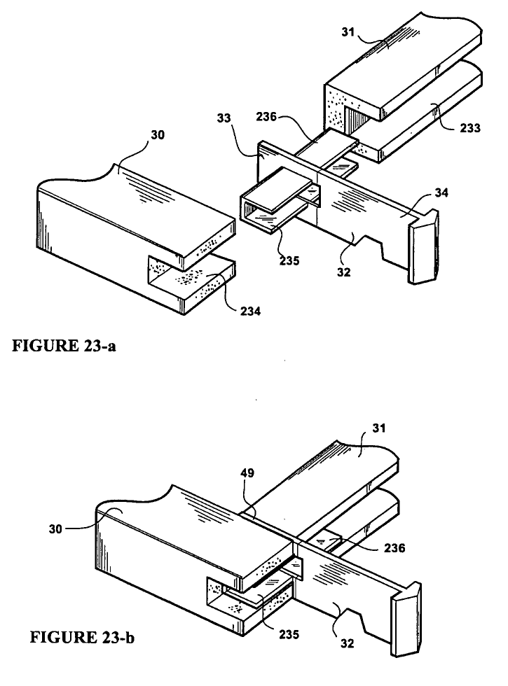

FIG. 23-a shows an exploded perspective detail of a vibration welded corner butt joint similar to the vibration welded joint shown in FIG. 20-a but with a further alternative configuration of the component holder 210. In this case, the component holder 210 is in the form of two U-channel wing extensions 235 and 236 to the first portion 33 of the junction piece 32.

The thermoplastic foam member 31 incorporates an outward facing U-channel opening 233. The end surface of the thermoplastic member 30 incorporates a milled U-channel opening 234. The U-channel wing extensions 235 and 236 fit within the two channel openings 233 and 234. In order to allow the junction piece 32 to be vibrated back and forth during the vibration welding process, the U-channels within the thermoplastic members 233 and 234 are configured to be slightly larger than the U-channel wing extensions 235 and 236.

FIG. 23-b shows a perspective detail of the vibration welded corner butt joint incorporating a U-channel component holder 210 as shown in FIG. 23-a. The first web portion 33 of the junction piece 32 is welded to the end surface of the member 31 and the side surface of the member 30. The advantage of the U-channel component holder 210 is that attachment hardware such as wheel devices (not shown) can be inserted into the U-channel opening and be supported within the wing web junction piece 32. Compared to the soft thermoplastic foam, the junction piece 32 may be fabricated from a harder thermoplastic material and so this allows for point loads to be more easily supported by the completed framing assembly.

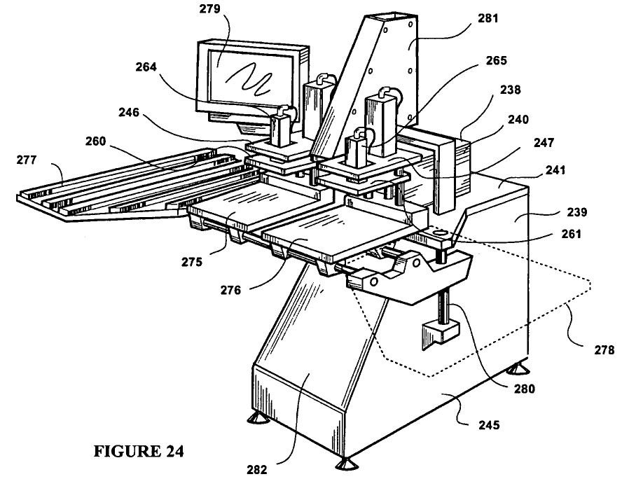

FIG. 24 shows a perspective view of vibration welding equipment that could be used for manufacturing vibratory welded joints of embodiments of the present invention. The vibratory welding equipment is comprised of two major components, labelled 238 and 239.

The first major component 238 includes: a linear movement vibratory head 240 and related support structure 241; a vibratory plate (not shown) attached to the vibratory head 240, and a junction piece clamping and holding means (not shown), also referred to herein as a junction piece fixture, which is fastened to the vibratory plate.

The second major component 239 includes: the equipment structure 245; two separate, independent clamping and positioning devices 246 and 247, also referred to herein as member fixtures, including clamp components 260 and 261 and platforms 275 and 276 for profile jigs; height adjustment means 280 for the clamping and positioning devices 246 and 247; side tables 277 and 278 with brush strips for supporting the thermoplastic members during the welding process; a gravity feed system 281 for junction piece loading, a recycling box for removable tabs (location only shown at 282), a computer monitor and system interface 279, which may include a user input device such as a keyboard, and an equipment control system (not shown).

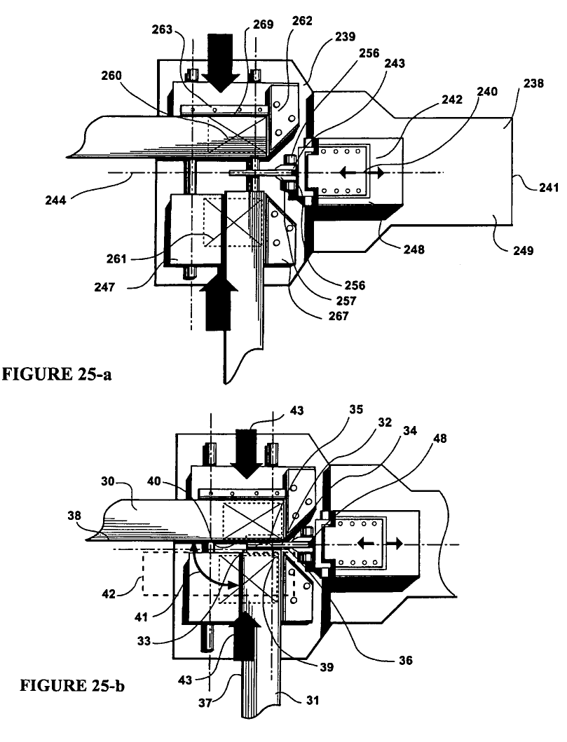

FIGS. 25-a and 25-b show plan views of the vibration welding equipment shown in FIG. 24 where the equipment is set up to weld a butt joint corner assembly as illustrated in FIGS. 1 to 19. In FIG. 25-a, the vibration welding equipment is shown in an open position and in FIG. 25-b, the equipment is shown in a weld cycle.

Individual components of the two major components 238 and 239 of the friction corner welding equipment are identified in FIG. 25-a. The first major equipment component 238 comprises a vibratory head and related support structure. A vibratory plate 242 is attached to the vibratory head 240 and a junction piece clamping and holding means 243 is fastened to the vibratory head. The purpose of the junction piece clamp 243 is to hold the second portion or removable tab 34 of the junction piece 32 firmly in position on a center line datum 244. Because of the various features that can be incorporated into the second portion of the junction piece 34, it should be noted that the center line datum 44 may not be strictly the geometric center line of the second portion 34 but is the geometric center line of the main body of the second portion 34 of the junction piece 32.

The linear movement vibration head 240 is locked in position but all the other welding operations are based on the centre line datum 244. As shown in FIG. 25-a, the vibratory head 240 is positioned to the front of the vibration apparatus 248. A counter weight 249 of the system may be located behind, below and around the surfaces of vibration coils. A vertical support for the junction piece clamping system 243 is attached to the horizontal vibratory head 240 and this allows for the clamping system 243 to be positioned and centered and to the front side of the vibratory head 240 and on the centre line datum line 244. Consequently, the removable second portion 34 of the junction piece 32 is always centered on the junction piece clamping and holding means 243 regardless of the thickness, shape or size of the second portion 34. The clamping means 243 cantilevers the junction piece 32 forward of the vibratory head 240 allowing access to the first welding portion 33 of the junction piece 32 that can be vibrated from below, above, and behind the thermoplastic members 30, 31.

The junction piece clamping and holding means 243 positions the junction piece 32 in the centre of the clamping jaws 256 and applies sufficient force to the removable second portion 34 to hold the junction piece 32 in position during the vibration welding process. The thickness of removable tab portion 34 of the junction piece 32 may range from 1 mm to 15 mm, for example, and the clamping jaws 256 allow for this variation in size and position the junction piece 32 on the centre line datum 244. Replaceable junction piece clamp inserts 257 allow for the accommodation of different geometric holding shapes such as the T-shaped extension 48.

The second major equipment component 239 of the example vibration welding equipment includes two separate, independent clamping and positioning devices 246 and 247 that hold the thermoplastic members 30 and 31 in position and then apply perpendicular pressure to the interposed junction piece. Each clamping device applies substantially equal pressure to the junction piece 32 at each welding surface of the members 30 and 31 to be welded, and in a direction that is normal to the interposed junction piece 32, which is moved linearly back and forth. The clamping and positioning devices 246 and 247 may also move toward the junction piece 32 as material of the members 30 and 31 is melted, so as to maintain substantially constant pressure on the junction piece. Pressure actuators (not shown) operatively coupled to the clamping and positioning devices 246 and 247 may provide such an engagement force between the first and second members 30 and 31 and the junction piece 32.

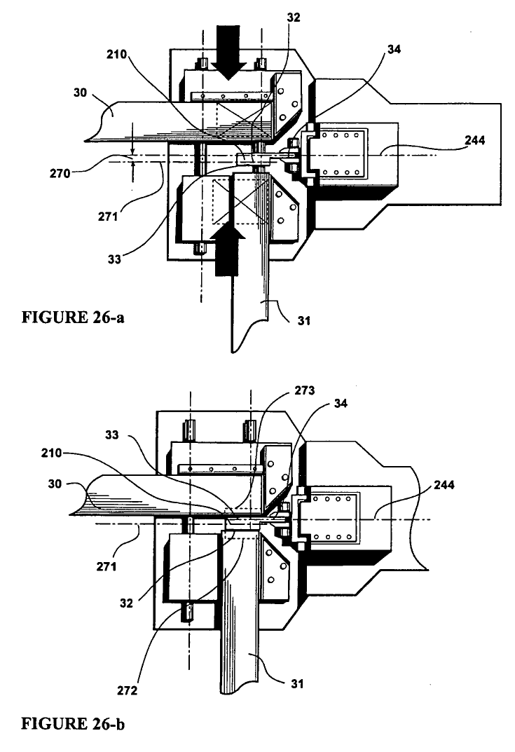

The thermoplastic member clamping and holding devices 246 and 247 are independent of the vibratory head component 240 and can move on both horizontal and vertical axes in some embodiments to position the member welding surfaces in the appropriate position relative to different junction piece configurations and weld positions of the clamped junction piece (See FIG. 26). Two separate member clamping components 260 and 261 clamp the thermoplastic members 30, 31 to the tables 275, 276 and position their surfaces 39, 40 to contact the corresponding surfaces 35, 36 of the junction piece 32. The first member clamp 260 positions the side face 40 of the member 30 to the first portion 33 of the junction piece 32, and using pressure actuators (not shown) may apply pressure 43 to an opposite side surface of the member 30, which opposite side surface is substantially parallel to the side surface 40.

The first clamp component 260 operates in conjunction with a position guide 262 and a side stop 263, which are located on the platform 275 and are at right angles to each other in the example shown. The side stop 263 allows the end surface of member 30 to be butted up to the position guide 262. Located at a right angle to the first side stop 263, the position guide 262 allows the side surface of the thermoplastic member to be forced against the opposite weld surface 40. Minimal clamping pressure is applied except for the clamping component 260, which prevents the member from moving upwards. These stops, guides and clamps hold the first member 30 in position during the pressuring phase of the vibration welding process. The clamp component 260 can be moved at angles ranging from 0° to 90° from the centre line datum 244.

The position guide 267 positions the end surface 39 of member 31 against the weld surface portion 33 of junction piece 32. The position guide 267, which may be in line with the position stop 262 during many welding operations, allows the side surface of the member 31 to be positioned against it. The clamping component 261 applies pressure downwards to hold the member 31 in position against the platform 276 during the vibratory welding process. The clamp component 261 can be moved at angles ranging from 0° to 90° from the centre line datum 244. This flexibility in the positioning of the clamping components 260 and 261 allows for conventional miter joints to be also produced using the vibration welding equipment.

Both of the member clamp components 260 and 261 may have interchangeable jigs 269 that allow for different profile sizes, shapes and configurations to be accommodated. These interchangeable jigs are supported on platforms 275 and 276 (See FIG. 24). Further stops and/or other structural elements for positioning or holding the members 30 and 31 may be integrated with the clamping components 260 and 261 and operated, for example, by the pneumatic cylinders 264 and 265 (See FIG. 24). Vertical motion and clamping pressure of the clamp components 260 and 261 themselves may also be controlled pneumatically, using main pneumatic cylinders shown in FIG. 24 on either side of the gravity feed system 281.

As shown in FIG. 25-b, during the vibratory welding process for a butt joint, the member clamp components 260 and 261 apply equal but possibly variable pressure to the weld surfaces 35 and 36 of the junction piece 32, and this pressure is applied through mechanical means (not shown). In some embodiments, a positioning system is operatively coupled to the clamping and positioning devices 246 and 247 and is operable to determine a dimension of the junction piece 32 and to control positions of the devices relative to the junction piece fixture 243 based on the determined dimension.

FIG. 25-a also illustrates that the welding surface on the member 30 partially defines an angle 41 in a plane 42 normal to the junction piece 32 between unwelded portions 37 and 38 of first and second thermoplastic members 31 and 32.

FIGS. 26-a and 26-b show plan views of the vibration welding equipment shown in FIG. 24 where the equipment is set up to weld a butt joint corner assembly incorporating different types of component holders as shown in FIGS. 20 to 22.

Depending on the design elements incorporated into the first portion 33 of the junction piece 32, a second predetermined datum line 271 is established. This predetermined datum line may be the reference baseline for the various movement, positioning and profile pressuring operations that occur during the weld cycle. Specifically, the amount of movement for profile pressuring of the junction piece 32 is determined from the predetermined datum line 271. In addition, the depth calculation for the amount of thermoplastic material to be melted during the weld cycle is also established equally from the predetermined datum line 271.

The position of the predetermined datum line 271 can vary depending on a number of factors, including: design of junction piece including type of component holder 210, design of profile shape of thermoplastic members 30 and 31, type of thermoplastic material used, and the finished visual appearance of the corner joint or vibratory welded product.

FIG. 26-a shows a plan view of the vibration welding equipment in an open position. The second portion or tab 34 of the junction piece 32 is clamped in position on a centre line datum 244 and the predetermined datum line 271 for the first portion 33 is offset from the centre line datum 244 by a distance 270.

FIG. 26-b shows a plan view of the vibration welding equipment during the weld cycle. The dotted lines indicate the channel recesses 272 and 273 formed in the thermoplastic profiles 30 and 31 in order to accommodate the component holder 210.

By using the dual datum line system as illustrated in FIGS. 26-a and 26-b, a wide variety of different types and sizes of junction pieces can be used to form vibratory welded joints.

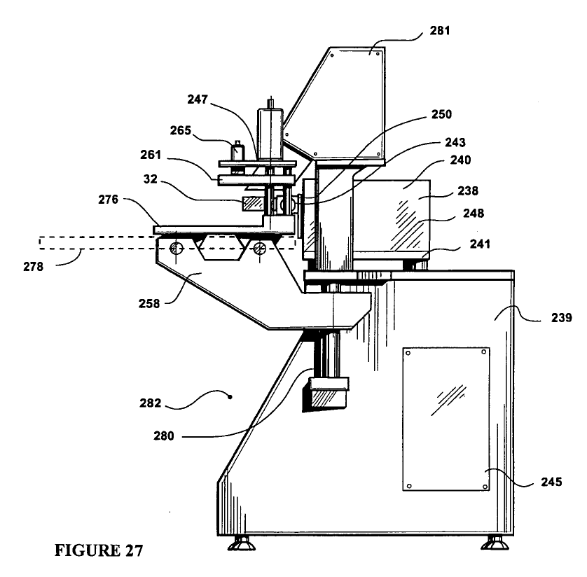

FIG. 27 shows an elevation view of the vibration corner welder as shown in FIG. 24. As noted above, the corner welder is comprised of two major components 238 and 239. The first major component 238 includes: a vibratory head 240 and related support structure 241; a horizontal vibratory plate (not shown) attached to the vibratory head 240, and a junction piece clamp 243 and support 250 attached to the vibratory plate. The second major component 239 includes: the equipment structure 245; two separate, independent clamping and positioning devices, one of which is shown at 247; height adjustment means 280 for the clamping and positioning devices; profile platforms, one of which is shown at 276, for supporting profile jigs (not shown); side tables, one of which is shown at 278, with strip brushes for supporting the thermoplastic members to be welded; a gravity in-feed, junction piece chamber 281, and a recycling box for removable junction piece tabs (location only shown at 282). Other components may also be provided, but are not visible or have not been specifically labelled in the view shown in FIG. 27.

The thermoplastic member clamping component support 258 is independent of the vibratory head component 240 and the height of clamping component can be adjusted by mechanical means 280 so that the member welding surfaces can be located in the appropriate position relative to different junction piece configurations and weld positions of the clamped junction piece 32.

Junction pieces 32 are loaded into the junction piece clamp 243 by means of a gravity feed system 281 that is located above the junction piece clamp 243 and attached to the main support structure 241. After the vibratory welding process is complete, the removable tab is cut off or otherwise removed, and the tab drops down for collection in a waste/recycling box at location 282.

What has been described is merely illustrative of the application of principles of embodiments of the invention. Other arrangements and methods can be implemented by those skilled in the art without departing from the scope of the present invention.

For example, references herein to welding surfaces partially defining angles are intended to cover embodiments in which a portion of a welding surface or one of multiple welding surfaces defines an angle. Similarly, references to a plane perpendicular to a junction piece are intended to cover embodiments in which the plane is perpendicular to a portion of a junction piece or one of multiple welding surfaces of a junction piece.

Variations of the embodiments shown in the drawings are also contemplated. A system for interconnecting a series of frame members to form a closed frame, for example, may include a respective welding apparatus of the type shown in FIGS. 24 to 27 for engaging and welding adjacent members simultaneously.

In addition, although described primarily in the context of joint structures, apparatus for welding such joint structures, and members and junction pieces which may be welded, other implementations of the invention are also contemplated, including welding methods for instance.

1. A welded joint structure comprising:
first and second thermoplastic members; and
an interposed junction piece vibratory welded to said first member at a first welding surface and to said second member at a second welding surface,
at least one of said first welding surface and said second welding surface partially defining an angle, in a plane normal to said interposed junction piece, between an unwelded portion of said first member and an unwelded portion of said second member.

2. (canceled)

3. The welded joint structure of claim 1, wherein each of said first member and said second member comprises an elongate member having an end surface and at least one side surface, wherein said first welding surface comprises a surface that is parallel to a side surface of said first member, and wherein said second welding surface comprises a surface that is parallel to said end surface of said second member.

4-9. (canceled)

10. The welded joint structure of claim 3, wherein said interposed junction piece comprises a substantially flat strip of thermoplastic material, wherein said end surface of said second member incorporates a channel recess, and wherein said side surface of said first member to which said first welding surface is parallel comprises a complementary channel recess.

11-12. (canceled)

13. The welded joint structure of claim 1, wherein said first welding surface, said second welding surface, and said interposed junction piece comprise multiple faces, and wherein a face of said multiple faces of said at least one of said first welding surface and said second welding surface partially defines said angle between said unwelded portion of said first member and said unwelded portion of said second member in a plane normal to a face of said multiple faces of said interposed junction piece.

14-16. (canceled)

17. The welded joint structure of claim 1, wherein said first member incorporates a channel recess comprising said first welding surface, wherein said second member incorporates a complementary channel recess comprising said second welding surface, and wherein said interposed junction piece incorporates a three-dimensional shape complementary to said channel recesses of said first member and said second member.

18-22. (canceled)

23. The welded joint structure of claim 1, wherein said junction piece comprises:
respective welding surfaces for forming vibratory welded bonds between said junction piece and said first and second thermoplastic members; and
a component holder, physically coupled to said respective welding surfaces, for enabling said junction piece to hold a further component.

24-35. (canceled)

36. An assembly incorporating a plurality of welded joint structures as claimed in claim 1.

37. A method for forming a vibratory welded connection between first and second members and a junction piece where said members and said junction piece are composed at least in part of thermoplastic material, said method comprising:
providing a junction piece having a first portion for welding to said first and second members;
holding said first and second members such that respective welding surfaces of said first and second members are positioned at a predetermined relative position in which at least one of said welding surfaces partially defines an angle, in a plane normal to said at least one welding surface, between an unwelded portion of said first member and an unwelded portion of said second member;
creating an engagement force between each of said respective welding surfaces of said first and second members and a respective opposite side of said first portion of said junction piece;
maintaining said engagement forces while vibrating said junction piece to create friction generated heat to melt material on said welding surfaces of said members and on each respective opposite side of said first portion of said junction piece, such melted material upon cooling forming a weld between said junction piece and said welding surfaces of said members.

38. The method of claim 37, wherein creating an engagement force comprises:
applying a mechanical force, in a direction towards said junction piece, on a respective surface of at least one of said first member and said second member that is substantially parallel to said welding surface of said at least one of said first member and said second member.

39. The method of claim 38, further comprising:
moving said first member and said second member in respective directions toward said junction piece as material is melted at interfaces between said first member and said junction piece and between said second member and said junction piece so as to maintain substantially even pressure at said interfaces.

40. (canceled)

41. The method of claim 37, wherein vibrating said junction piece comprises vibrating said junction piece in a direction parallel to at least one of said unwelded portion of said first member and said unwelded portion of said second member.

42-45. (canceled)

46. The method of claim 45, wherein said junction piece further comprises a component holder, physically coupled to said first portion, for enabling said junction piece to hold a further component and wherein vibrating comprises:
mounting said component holder to a fixture connected to a vibratory head; and
vibrating said junction piece by means of said vibratory head.

47-48. (canceled)

49. The method of claim 37, further comprising:
determining a dimension of said junction piece; and
automatically controlling positions of member fixtures relative to said junction piece based on said determined dimension, said member fixtures being for respectively holding said first and second members.

50. The method of claim 49, wherein said junction piece comprises a first portion for welding to said first and second members and a second portion extending from said first portion for coupling to a vibratory head, said first portion and said second portion having a common datum relative to said welded connection, and wherein controlling comprises controlling positions of said member fixtures to hold said first and second members at respective predetermined distances from said common datum.

51. The method of claim 49, wherein said junction piece comprises a first portion for welding to said first and second members and a second portion extending from said first portion for coupling to a vibratory head, said first portion being offset from said second portion such that said first portion has a datum relative to said welded connection and said second portion has a different datum than said first portion, and wherein controlling comprises controlling positions of said member fixtures to hold said first and second members at respective predetermined distances from said datum of said first portion.

52-53. (canceled)

54. An apparatus for forming a vibratory welded connection between first and second members and a junction piece, said members and said junction piece being composed at least in part of thermoplastic material, said apparatus comprising:
a vibratory head;
a junction piece fixture, connected to said vibratory head, for holding said junction piece; and
respective member fixtures for holding said first and second members such that respective welding surfaces of said first and second members are positioned at a predetermined relative position in which at least one of said welding surfaces partially defines an angle, in a plane normal to said at least one welding surface, between an unwelded portion of said first member and an unwelded portion of said second member, said member fixtures supporting said first and second members for movement independently of said vibratory head.

55. The apparatus of claim 54, further comprising:
a positioning system operatively coupled to said member fixtures and operable to determine a dimension of said junction piece and to control positions of said member fixtures relative to said junction piece fixture based on said determined dimension.

56. The apparatus of claim 54, wherein said junction piece comprises a first portion for welding to said first and second members and a second portion extending from said first portion, said junction piece fixture being operable to hold said second portion of said junction piece, wherein said first portion and said second portion have a common datum relative to said welded connection, and wherein said positioning system is operable to position said member fixtures to hold said first and second members at respective predetermined distances from said common datum.

57. The apparatus of claim 54, wherein said junction piece comprises a first portion for welding to said first and second members and a second portion extending from said first portion, said junction piece fixture being operable to hold said second portion of said junction piece, wherein said first portion is offset from said second portion such that said first portion has a datum relative to said welded connection and said second portion has a different datum than said first portion, and wherein said positioning system is operable to position said member fixtures to hold said first and second members at respective predetermined distances from said datum of said first portion.

58-72. (canceled)

73. A system for interconnecting a series of elongate frame members to form a closed frame, wherein adjacent ends of adjoining frame members are engaged as first and second members within a respective apparatus as claimed in claim 54.
